(19) United States
(12) Patent Application Publication
(10) Pub. No.: US 2003/0217352 A1
(43) Pub. Date: Nov. 20, 2003

(54) Script processing apparatus, script processing method, and script processing program

(76) Inventors: Kouji Ueno, Kanagawa-ken (JP); Kentaro Kamahora, Kanagawa-ken (JP); Tetsuo Hasegawa, Tokyo (JP); Akihiko Ohsuga, Kanagawa-ken (JP)

Correspondence Address: Finnegan, Henderson, Farabow,, Garrett & Dunner, L.L.P., 1300 I Street, N.W., Washington, DC, 20005-3315, US

(21) Appl. No.: 10/392,969

(22) Filed: Mar. 21, 2003

(30) Foreign Application Priority Data
Mar. 22, 2002 (JP) P2002-080067
Feb. 21, 2003 (JP) P2003-043579

(51) Int. Cl. G06F 9/44

(52) U.S. Cl. 717/115; 717/139

(57) ABSTRACT

Systems and methods for using a main script program include a function that prompts a user to enter an input script program while a main script program executes. An ACL (Access Control List) defines commands used by the input script program. When a user executes the main script program, a prompt function prompts the user to enter the input script program. Program execution continues and the user's computer determines whether the input script program is executable based upon the ACL contained in the main script program. Accordingly, the input script program may only execute a specified range of authorized commands.

### CROSS-REFERENCES TO RELATED APPLICATIONS

This application is based upon and claims the benefit of priority from Japanese Patent Application No. 2002-080067, filed Mar. 22, 2002, and Japanese Patent Application No. 2003-043579, filed Feb. 21, 2003, the entire contents of which are incorporated herein by reference.

### DESCRIPTION OF THE INVENTION

1. Field of the Invention

The present invention relates to a script processing apparatus and a script processing method capable of restricting execution of a script program newly entered by a user while another script program is executing on the user's computer.

2. Background of the Invention

Recently, “scripting technology” capable of immediately analyzing and executing programs have become of wide interest. Because scripting technology can largely improve the efficiency of developing software, scripting technology has been widely employed. This is especially so in the Web services field, which often involves a large number of varied computer systems.

Scripting technology may be implemented by using a script and an interpreter. The script is written in a scripting language that is high level and more easily readable by persons than conventional programming languages. The interpreter directly reads such a script to analyze and/or execute the script.

In scripting technology, while an interpreter executes a script, another new script can be read/executed from a file system, a network, a user interface, or the like. Such a function is typically provided as an “eval” command. Hereafter, a function with such characteristics will be referred to as an “eval” function.

On the other hand, generally, access control technology executed based upon an access control list (ACL) has been widely used to prevent the destruction of a host system by restricting the resources various software programs can access. Such access control technology involves restricting access to resources based upon authority levels corresponding to authenticated users. The ACL typically includes a table where a decision is made as to whether or not a specific user can access a specific resource. Controlling access authority based upon an authenticated user's authority level is referred to as “authorization.”

For example, Java™2 includes access control technology that is combined with a programming language. In Java™2, authorization of a class is carried out based upon either a load source of a class file or public key authentication information included in the class file. An access right with respect to a specific resource is controlled based upon an ACL. The ACL allows a manager of an execution environment under which Java™ application software is executed to protect computer systems and prevent execution of illegal programs.

Examples of a technology resembling the access control technology for a scripting language include the taint mode of the Perl language and the ACL of the Lotus script language. In the case of the taint mode of the Perl language, the ACL cannot be changed at all. The Perl language also prohibits any attempted external access by data derived from data obtained outside of a program. In the case of an ACL of the Lotus script language, a change can be made as to whether or not a specific user authorized by a Lotus Notes system has both an authority to read a specific document and an authority to edit the specific document.

For example, when a script is input by a user of a plurality of computers connected to a network, it is not certain that the user input is safe. As a consequence, a script programmer would like to restrict certain eval functions so that the operation of a script is limited to a range of predicted functionality.

However, in the taint mode of the Perl language, external output is never allowed if there has been any external input. Accordingly, the script programmer cannot restrict certain content involving external input while allowing safe content. In addition, authorization varies based on the operating system. Finally, because an ACL of a Lotus script controls only the access right with respect to the static document, an ACL control cannot be applied to solve this problem.

### SUMMARY OF THE INVENTION

In accordance with an embodiment of the invention, a script processing apparatus includes an execution unit configured to execute a first script program and a second script program, wherein said first script program includes restriction information used to restrict execution of said second script program, and wherein said second script program is inputted during execution of said first script program. A restriction information copying unit is configured to copy said restriction information in said first script program. A restriction information inspecting unit is configured to inspect said inputted second script program and determine whether or not said inputted second script program is executable based upon said restriction information copied by said restriction information copying unit. Additionally, said execution unit ceases executing said second script program when said restriction information inspecting unit determines that said second script program is not executable.

In accordance with another embodiment of the invention, a script processing apparatus includes an execution unit configured to execute a first script program and a second script program, wherein said first script program includes restriction information that defines at least one authorized command in said second script program, and wherein said second script program is inputted while executing said first script program. A restriction information inspecting unit is configured to inspect said inputted second script program and is configured to determine whether or not said inputted second script program is executable based upon said restriction information in said first script program. Additionally, said execution unit ceases executing said second script program when said restriction information inspecting unit determines that said second script program is not executable.

In accordance with another embodiment of the invention, a script processing apparatus includes an analyzing unit configured to analyze a first script program and a second script program, wherein said first script program includes restriction information that defines at least one authorized command in said second script program, and wherein said second script program is inputted by a user. An execution unit executes said first script program and said second script program is analyzed by said analyzing unit. A restriction information inspecting unit inspects said inputted second script program and is configured to determine whether or not said inputted second script program is executable based upon said restriction information in said first script program. Additionally, said execution unit ceases executing said second script program when said restriction information inspecting unit determines that said second script program is not executable.

In accordance with another embodiment of the invention, an interpreter for use by a computer apparatus includes analyzing program code configured to analyze a first script program and a second script program, wherein said first script program includes restriction information that defines at least one authorized command in said second script program, and wherein said second script program is inputted by a user. Execution program code executes said first script program and said second script program is analyzed by said analyzing program code. Restriction information copying program code is configured to copy said restriction information in said first script program. Restriction information inspecting program code is configured to inspect said inputted second script program and configured to determine whether or not said inputted second script program is executable according to said restriction information copied by said restriction copying program code. Additionally, said execution program code ceases executing said second script program when said restriction information inspecting program code determines that said second script program is not executable.

In accordance with another embodiment of the invention, a computer apparatus includes a processor and an interpreter executed by said processor, wherein said interpreter includes analyzing program code configured to analyze a first script program and a second script program, wherein said first script program includes restriction information that defines at least one authorized command in said second script program, and wherein said second script program is inputted by a user. Execution program code is configured to execute said first script program and said second script program analyzed by said analyzing program code. Restriction information copying program code is configured to copy said restriction information in said first script program. Restriction information inspecting program code is configured to inspect said inputted second script program and is configured to determine whether or not said inputted second script program is executable based upon said restriction information copied by said restriction copying program code. Additionally, said execution program code ceases executing said second script program when said restriction information inspecting program code determines that said second script program is not executable.

In accordance with another embodiment of the invention, a script processing method executes a first script program, said first script program including restriction information that defines at least one authorized command in a second script program. The method includes copying the restriction information from said first script program, inputting said second script program while executing said first script program, inspecting said inputted second script program and determining whether or not said inputted second script program is executable in reference to the copied restriction information. Execution of said second script program ceases if a determination of said determining is not executable.

In accordance with another embodiment of the invention, a script processing method includes executing a first script program, prompting an input of a second script program while said first script program is executing, receiving said second script program, determining whether or not said received second script program is executable based upon restriction information contained in said first script program, and executing said second script program when said determining determines said second script program is executable. Execution of said second script program ceases if said determining determined said second script program is not executable.

In accordance with another embodiment of the invention, a script processing method includes executing a first script program, copying restriction information in said first scripting program, prompting an input of a second script program while said first script program executes, receiving said second script program, and determining whether or not said received second script program is executable with reference to said copied restriction information executing said second script program when a determination of said determining step is executable. Execution of said second script program ceases if said determining determines said second script program is not executable.

In accordance with another embodiment of the invention, a script processing program product for executing a script program on a computer includes first program code executing a first script program and a second script program, second program code accepting an input of said second script program while said first script program executes, and third program code determining whether or not said accepted second script program is executable based upon restriction information contained in said first script program. If the determination of said third program code is that said second script program not executable, said third program code ceases execution of the first program code.

In accordance with another embodiment of the invention, a script processing program product for executing a script program on a computer includes first program code executing a first script program and a second script program, second program code copying restriction information contained in said first script program, third program code accepting an input of said second script program while said first script program executes, and fourth program code determining whether or not said accepted third script program is executable with reference to copied restriction information by said second program code. If the determination of said fourth program code is that said second script program is not executable, said fourth program code ceases execution of the first program code.

In accordance with another embodiment of the invention, a script program product executed by a computer includes first program code for prompting an input of an input script program, restriction information for restricting a command useable by the input script program inputted by said prompt function, and second program code configured to inspect whether or not said input script program inputted by said first program code is executable based upon said restriction information, and configured to cease execution of said input script program when an inspection result indicates that said input script program is not executable.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed. The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a diagram showing a system according to an embodiment of the present invention;

FIG. 2 is a flow chart describing writing a main script according to an embodiment of the present invention;

FIG. 3 is a flow chart explaining process operations when the main script is executed by an interpreter;

FIG. 4 is a diagram showing an example of the main script;

FIG. 5 is a diagram indicating an example of an internal expression under an initial state produced by all command lines of the main script;

FIG. 6 is a diagram representing an example of an internal expression after three proc commands have been executed;

FIG. 7 is a diagram showing an example of an internal expression after a set command has been executed;

FIG. 8 is an example of a normal input script;

FIG. 9 is an example of a copied ACL (Access Control List);

FIG. 10 is a diagram showing an example of an internal expression produced from the input script;

FIG. 11 is an example of an erroneous input script; and

FIG. 12 is a diagram showing an example of an internal expression corresponding to the input script of FIG. 11.

### DESCRIPTION OF THE EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

It should be understood that respective “units” employed in the following embodiment of the present invention are conceptual ideas corresponding to respective functions of the embodiment, and therefore, need not necessarily correspond to specific hardware and specific software routines in a one-to-one correspondence. In particular, although internal structures of interpreters differ based on software, various internal structures may be employed in this embodiment.

In the following description, a script program, which is formed by a script programmer and supplied to a user, is referred to as a “main script.” When the user executes the main script, a script program that is subsequently newly entered by the user is referred to as an “input script.”

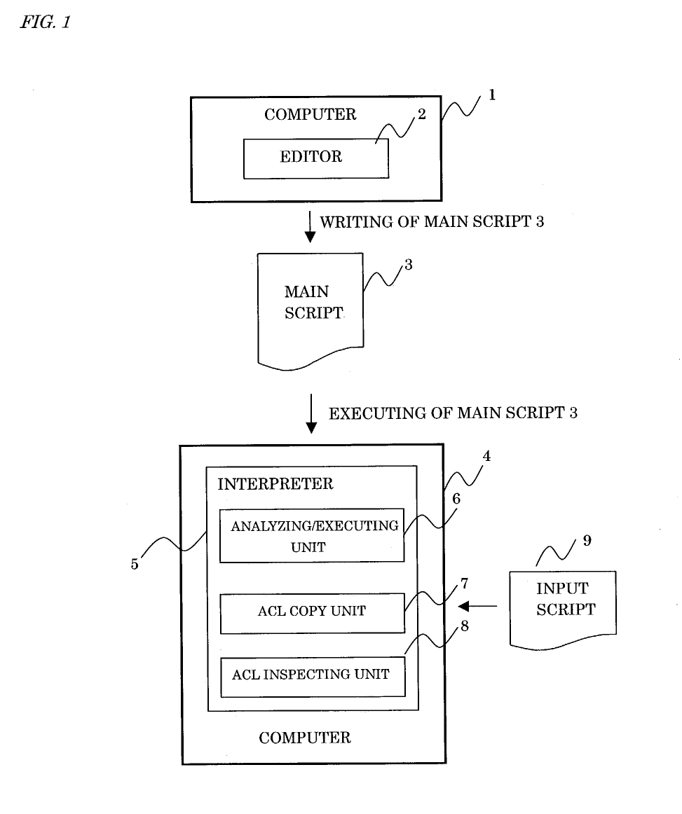

FIG. 1 is a diagram showing a system according to an embodiment of the present invention. A computer 1, such as a personal computer or a portable telephone, includes an editor unit 2, which executes a document editing operation. A script programmer creates a main script 3 by using the editor unit 2. The main script 3 is then outputted and provided to a user.

Another computer 4 includes interpreter 5, which executes the main script 3. Typically, the interpreter 5 is a software program. The interpreter 5 includes an analyzing/executing unit 6, which reads and analyzes each command line of the main script 3, produces an internal expression, and executes the produced internal expression. Information, such as all of the commands and all of the data related to analyzing/executing operations of the main script 3, is stored in a memory (not shown) of the computer 4.

Also, the interpreter 5 includes an ACL (Access Control List) copying unit 7, and an ACL inspecting unit 8. The ACL copying unit 7 copies a list of authorized and/or unauthorized script commands, which have been previously defined within the main script 3 by the script programmer in case an input script 9 from the user is accepted while the main script 3 executes. The list of the authorized and/or unauthorized script commands will be referred to as an ACL (Access Control List). (The ACL inspecting unit 8 references an ACL copied by the ACL copying unit 7 while the input script 9 is executed, and confirms whether or not the script command is authorized.

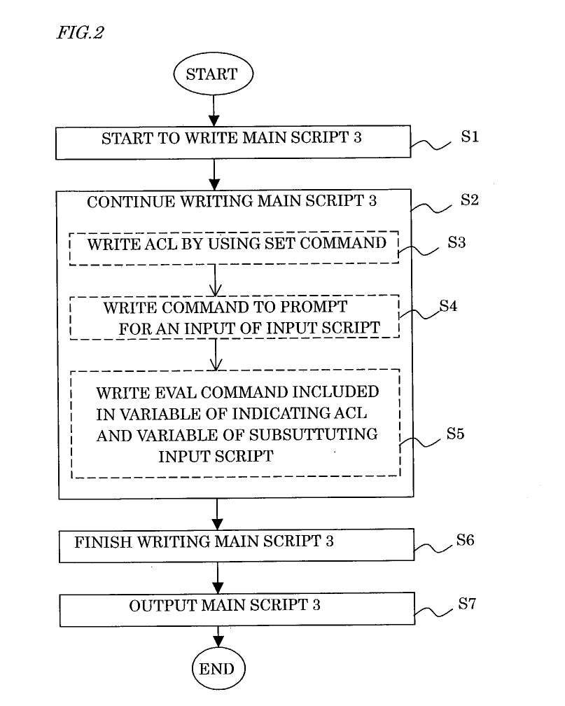

FIG. 2 shows a flow chart describing writing the main script 3. A script programmer composes the main script 3 by using the editor 2 of the computer 1 (step S1). The script programmer continues to compose the main script 3 (step S2). If the script programmer intends to cause a user who uses the main script 3 to enter the input script 9 while the main script 3 is executing, the script programmer executes the next three steps (S3 to S5).

The script programmer determines an authorized command and/or an unauthorized command to restrict the script commands that the input script 9 entered by the user may execute. The script programmer then describes these authorized and/or unauthorized commands as an ACL by using a set command (step S3). Also, the script programmer describes a command for instructing the user of the main script 3 to input the input script 9 (step S4).

The script programmer also adds both a parameter for designating the set ACL and another parameter for replacing the input script 9 by a command (hereinafter referred to as an “eval command”), which is evaluated based upon the ACL inspection to describe the eval command (step S5). As is apparent from the foregoing description, the process defined in the above-described steps S3 to S5 may be reversed depending upon the type of the implemented script language.

Although descriptions of script commands other than the descriptions defined in steps S3 to S5 are not explained in the above-described flow chart, the script programmer may describe other script commands such that composing of the main script 3 is finished (step S6). Finally, the editor unit 2 outputs the completed main script 3 for use by the user (step S7).

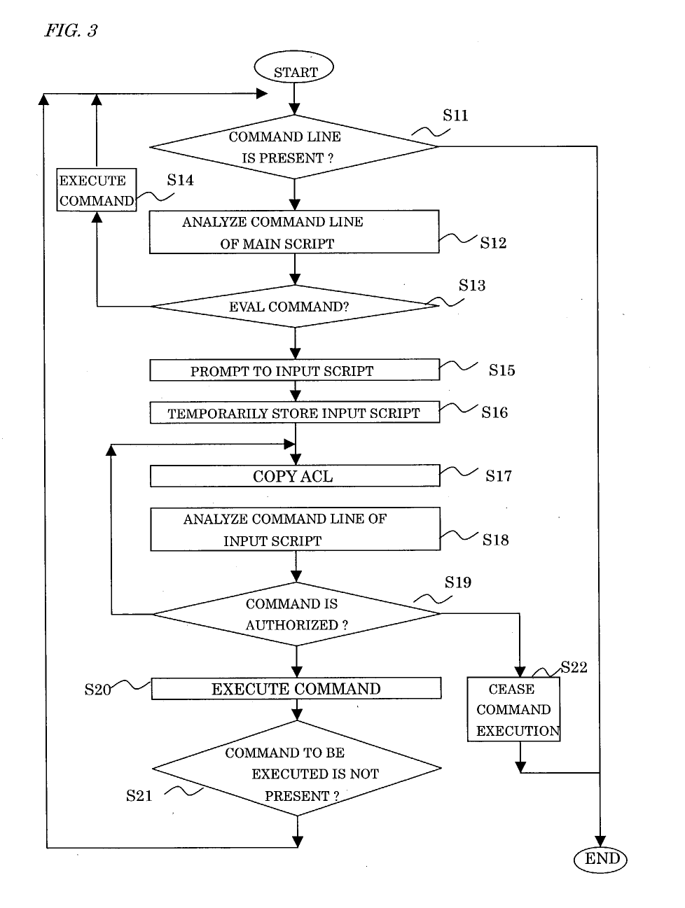

FIG. 3 shows a flow chart describing process operations executed when the interpreter 5 executes the main script 3. The user acquires the main script 3 composed by the script programmer and executes the main script 3 by using the interpreter 5 of the computer 4. The analyzing/executing unit 6 determines whether or not a command line for execution is present in the main script 3 (step S11). In the case that the analyzing/executing unit 6 judges that the command line for execution is not present, the execution of the main script 3 ends. On the other hand, if the command line for execution is present, the analyzing/executing unit 6 reads out the command line for execution from the main script 3, and then analyzes the command line (step S12).

Next, the analyzing/executing unit 6 determines whether or not a command contained in the analysis result corresponds to the eval command (step S13). As a result, if the contained command does not correspond to the eval command, then the analyzing/executing unit 6 produces an internal expression, executes the contained command based upon the produced internal expression (step S14), and the process operation returns to step S11.

On the other hand, if the analyzing/executing unit 6 determines that the command contained in the analysis result corresponds to the eval command in step S13, then the analyzing/executing unit 6 analyzes the “command for entering input script,” which is designated by the parameter added to the eval command. The analyzing/executing unit 6 then produces an internal expression, and executes the command to enter the input script based upon the internal expression (step S15). As a result, the computer 4 prompts the user to enter the input script. Then, the user enters the input script 9. The entered input script 9 is temporarily stored (step S16).

Next, the ACL copying unit 7 copies an ACL designated by another parameter contained in the eval command to the memory (not shown) (step S17). At this stage, the execution of the main script 3 is interrupted. The analyzing/executing unit 6 replaces the temporarily stored input script 9 into a parameter, and then reads and analyzes a command line from the replaced input script 9 (step S18).

Next, the ACL inspecting unit 8 determines whether or not the command contained in the analysis result corresponds to a command authorized by the script programmer with reference to the ACL copied into memory by the ACL copying unit 7 (step S19). As a result of the determination in the step S19, if the contained command corresponds to the authorized command, then the analyzing/executing unit 6 produces an internal expression of a command line containing the authorized command, and executes the authorized command based upon the produced internal expression (step S20). Then, the ACL inspecting unit 8 determines whether or not there is another command for subsequent execution (step S21). If there is a command for subsequent execution, then the process operation returns to the previous step S18.

As a result of the confirmation in step S19, when the command contained in the analysis result corresponds to an unauthorized command, the analyzing/executing unit 6 ceases to execute commands (step S22), and displays, for example, an error message.

As a result of the determination made in step S21, if there is not a command for subsequent execution, then the execution of the input script 9 normally ends and the process operation returns to the previous step S11. As a result, the interrupted analyzing/executing operation of the main script 3 continues execution.

As previously described, in accordance with this embodiment, the script programmer that composes the main script 3 that causes the user to input the input script 9 may allow the input script 9 to execute within only a specific range of authorized commands.

In the above-description of FIG. 3, the command lines of the respective script programs were analyzed/executed in sequence line by line. Alternatively, the system may be arranged in such a manner that after all of the command lines of the respective script programs have been analyzed, the analyzed commands may be executed. Also, if a control operation is carried out such that a command analyzing operation is executed prior to a command executing operation, then the command analyzing operation and the command executing operation may constitute separate programs and may operate in a parallel manner. Such variations may differ based upon the specifications of a particular script language.

Next, another example of this embodiment is explained in further detail. The present example exemplifies a main script 3 that dynamically displays a character by using the “Tcl” language corresponding to one of the script languages. First, the script programmer composes a main script 3, as illustrated in FIG. 4, in accordance with the flow chart of FIG. 2. The following describes the main script 3 of FIG. 4.

First, the symbols used in the main script 3 are explained as follows. A text (statement) described in the main script 3 prefaced by a symbol [#] indicates that the text is a comment describing the program that follows. Also, symbol “{ }” indicates that program segments are part of the same programming function, symbol “$” shows such a value is obtained by replacing a value of a variable name listed subsequent to the symbol “$”, and symbol “[ ]” signifies that a command is obtained by executing the command shown between the brackets “[ ]”.

A proc command corresponds to a (procedure) command for defining a function, and is represented as “proc A {B} {C}”. Symbol “A” is the name of a function to be defined, symbol “B” is a parameter of the function, and symbol “C” represents the body of the function. In the main script 3, a function “read-textarea,” which requires a character string written into the text area, is defined by a proc command. A function “walk,” which walks or steps through the command lines, is defined by a proc command. Also, a function “dir,” which indicates the direction of a character is changed by {num}, is defined by a proc command.

A set command corresponds to a (set) command for setting a value, and is expressed by “set A {B}.” Symbol “A” shows a variable (name), and symbol B indicates a value that is replaced by variable “A.” In the main script 3, [function default deny (implies that execution of command under default)] and [function allow “walk dir” (implies that walk, dir commands may be executed)], are substituted for a variable my-acl by the set command.

An eval command corresponds to such an (evaluate) command for evaluating while inspecting based upon the ACL by the ACL inspecting unit 8, and is expressed as “eval A B.” Symbol “A” indicates the ACL, and symbol “B” shows a subject to be evaluated. In the main script 3, a result obtained by executing the function “read-textarea” is evaluated by the eval command while the result is inspected by symbol “A” and the code “function default deny, function allow ” walk dir “” in the ACL inspecting unit 8.

The function “read-textarea” is defined as a function that acquires a character string written in the text area by the proc command, and “function default deny, function allow ” walk dir “” is the ACL. In other words, the eval command employed in this example evaluates the character sting inputted by the user while the character string is inspected by the ACL inspecting unit 8 based upon the ACL defined by the main script 3.

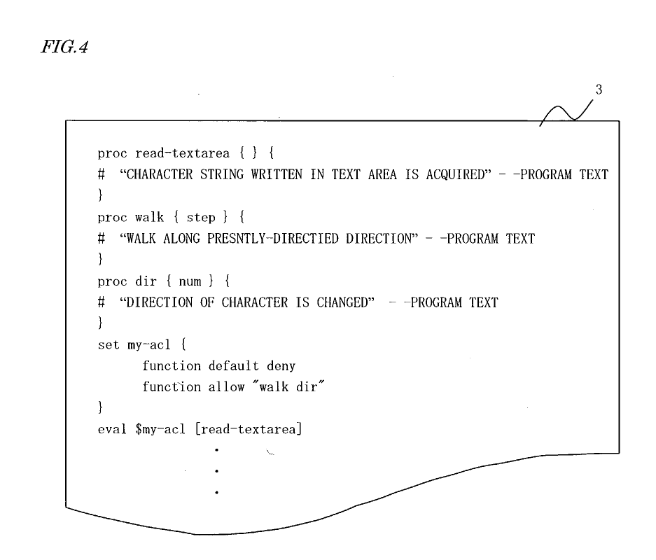

The user acquires the main script 3 of FIG. 4, and commences the process operations shown in FIG. 3 by employing the interpreter 5 of the computer 4. FIG. 5 to FIG. 7 indicate internal expressions of the main script 3 while the main script 3 is executed.

An internal expression is expanded to a memory (not shown). While the analyzing/executing unit 6 produces an internal expression when a command is executed, the analyzing/executing unit 6 executes the command based upon the produced internal expression. An internal expression includes a command table, a pointer, and a variable table. In the command table, command names, parameters of the commands, and bodies of the commands are stored in correspondence with each other. The pointer indicates an execution point of a command contained in the command table, which is executed by the analyzing/executing unit 6. In the variable table, names of variables and contents of the variables are stored in correspondence with each other. Although the drawings represent a condition that the internal expressions of all of the command lines have been produced (“main” of command table), originally, an internal expression of a command line is added every time a command line executes.

The analyzing/executing unit 6 analyzes the main script 3 to produce an internal expression. FIG. 5 represents a produced internal expression under an initial condition. As shown in FIG. 5, the analyzing/executing unit 6 provides a command named “main” in the command table, and stores an analysis result that process sequences are added to the contents thereof.

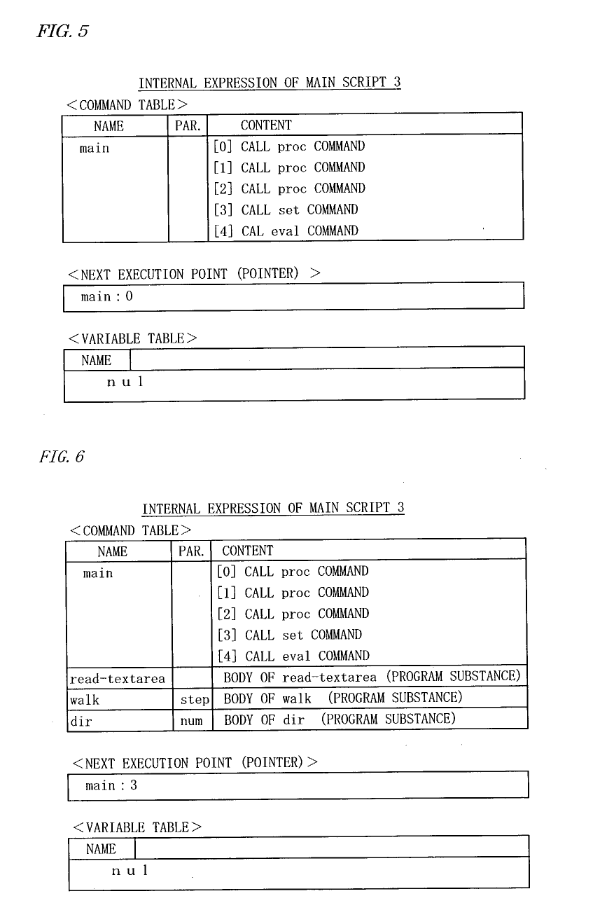

Next, the analyzing/executing unit 6 sequentially executes positions indicated by the pointer. The analyzing/executing unit 6 executes the respective proc commands defined from [0] up to [2] in this example, adds commands defined by the proc commands, parameters thereof, and the substance of programs for executing these commands in the command table in correspondence with each other. An internal expression produced at this time is given in FIG. 6.

In FIG. 6, the respective columns of “read-textarea”, “walk”, “dir” are added to the command table. Also, the pointer becomes “main:3.” Next, the analyzing/executing unit 6 executes a set command calling the operation of [3] indicated by the pointer. When the analyzing/executing unit 6 executes the set command, both a name of a variable and a content of the variable for replacement are stored in a variable table of the internal expression in correspondence with each other.

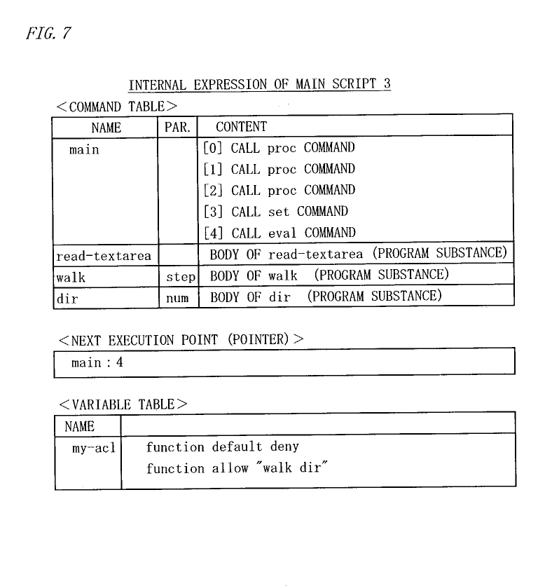

An internal expression of main script 3 is represented in FIG. 7. In FIG. 7, a variable “my-acl” is stored in the name of the variable table, and [function default deny, function allow “walk dir”] is stored in the content of the variable table. Also, the pointer is advanced by one point to become “main:4.”

Next, the analyzing/executing unit 6 executes an eval command calling operation [4] indicated by the pointer. The eval command includes two parameters: “$my-acl” and [read-textarea]. The parameter “$my-acl” is replaced by the content [function default deny, function allow “walk dir”] of variable “my-acl.” On the other hand, while the parameter read-textarea is handled as a script program, a content (program substance) of read-textarea is called out from the command table for execution. As a consequence, the analyzing/executing unit 6 prompts the user to enter an input script 9.

In this case, the input script 9 entered by the user corresponds to any one of two cases. In the first case, a normal input script 9 (an input script within a range intended by the script programmer) is entered. In the second case, an erroneous input script 9 is entered. These two cases will now be described.

1) Normal Input Script Entered

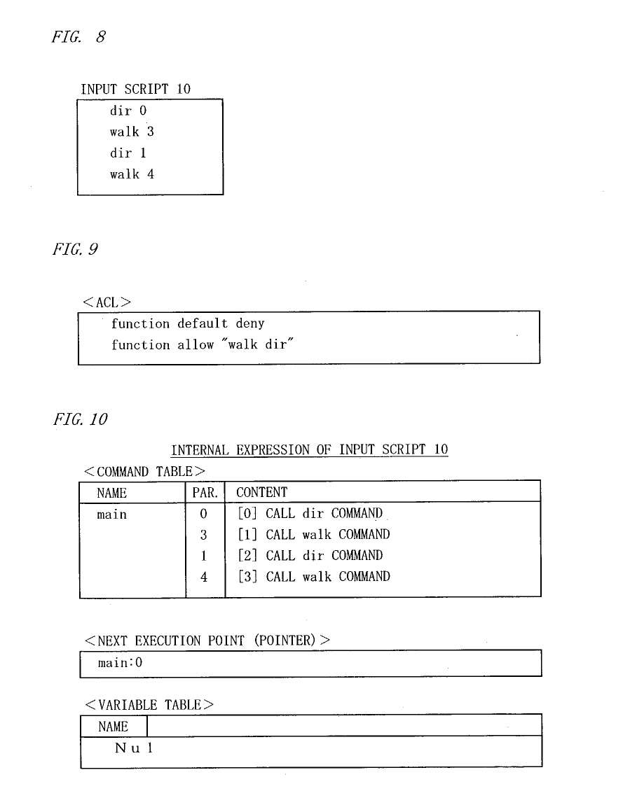

The following describes the case where an input script 10 entered by the user corresponds to an input script 9 of FIG. 8 that contains only authorized commands. This input script 9 indicates “direct to upper of screen,” “walk by three steps,” “direct to right of screen,” and “walk by four steps.” This input script 9 of FIG. 8 is temporarily held.

The analyzing/executing unit 6 supplies the temporarily held input script 9 of FIG. 8 to the analyzing/executing unit 6, and the content of the variable “my-acl” is copied to another storage area of the memory by the ACL copying unit 7. The content of this variable “my-acl” corresponds to the ACL, which is defined by the script programmer. The copied ACL is indicated in FIG. 9. At this stage, execution of the main script 3 is interrupted, and then the process operation advances to analyzing and executing the input script 9. The analyzing/executing unit 6 analyzes the input script 9, and sequentially produces a new internal expression, which is different from the main script 3 from the analysis result.

FIG. 10 shows an internal expression produced from the input script 9. Next, the analyzing/executing unit 6 sequentially executes the produced internal expressions (FIG. 10) of the input script 9. First, the analyzing/executing unit 6 calls a dir command pointed by a pointer “main:0.” The ACL inspecting unit 8 investigates whether or not the called dir command corresponds to an authorized command with reference to the copied ACL. In this example, since the dir command corresponds to an authorized command, the analyzing/executing unit 6 executes the dir command. When the command execution finishes, the pointer is incremented to “main:1.” Because any of the respective commands of the input script 9 in the example of FIG. 8 correspond to authorized commands, the sequential operation is successively repeated, and thus, the commands are inspected/executed.

When all of the input scripts 9 are completed, the execution of the main script 3, which was interrupted, resumes execution. The eval command corresponds to a command capable of executing the above-described process operations, so that the execution of this eval command may be accomplished. As a consequence, the analyzing/executing unit 6 increments the pointer of the internal expression of the main script 3 by 1. It should be understood that explanations of process operations subsequent to this process operation are omitted.

2) Erroneous Input Script Entered

The following describes the case where an input script 9 of FIG. 11 is entered and an unauthorized command is contained in the input script 9 entered by the user. This input script 9 intends to “direct to upper of screen,” “walk by three steps,” “jump two times,” “direct to right of screen” and “walk by four steps.” The analyzing/executing unit 6 analyzes this input script 9 (FIG. 11), and sequentially produces a new internal expression that is different from the main script 3 from the analysis result.

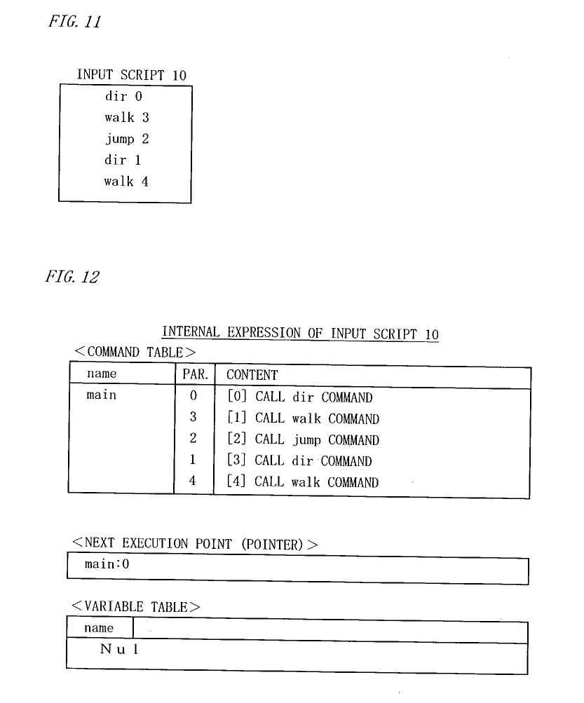

FIG. 12 shows an internal expression produced from the input script 9. Next, the analyzing/executing unit 6 executes the produced internal expressions. First, when the pointers are both “main:0” and “main:1,” the process operation is carried out under a normal condition similar to when the normal input script 9 is entered (as explained in the above case 1).

Next, the analyzing/executing unit 6 calls a jump command, which is pointed to by a pointer “main:2.” The ACL inspecting unit 8 inspects whether or not the jump command corresponds to an authorized jump command with reference to the copied ACL. As a result of this inspection, the ACL inspecting unit 8 judges that the jump command corresponds to an unauthorized command. In this example, execution of the input script 9 (and also of main script 3) ceases at this stage.

As previously described, in this embodiment, in the case where an input script 9 containing an unauthorized command is entered by the user, the script processing apparatus may execute the control operation so that the main script 3 cannot be executed. In accordance with this embodiment, in a script program, when the script program is executed, the additional script program (input script 9) that is inputted by the user can be executed within only a range of authorized commands.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A script processing apparatus comprising:
an execution unit configured to execute a first script program and a second script program, wherein said first script program includes restriction information used to restrict execution of said second script program, and wherein said second script program is inputted during execution of said first script program;
a restriction information copying unit configured to copy said restriction information in said first script program; and
a restriction information inspecting unit configured to inspect said inputted second script program and determining whether or not said inputted second script program is executable based upon said restriction information copied by said restriction information copying unit,
wherein said execution unit ceases executing said second script program when said restriction information inspecting unit determines that said second script program is not executable.

2. A script processing apparatus as in claim 1, wherein said execution unit continuously executes said second script program when said restriction information inspecting unit determines that said second script program is executable.

3. A script processing apparatus as in claim 1, wherein said restriction information defines at least one authorized command.

4. A script processing apparatus as in claim 1, wherein said restriction information defines at least one unauthorized command.

5. A script processing apparatus as in claim 1, wherein said first script program is distributed from a distributor.

6. A script processing apparatus comprising:
an execution unit configured to execute a first script program and a second script program, wherein said first script program includes restriction information that defines at least one authorized command in said second script program, and wherein said second script program is inputted while executing said first script program; and
a restriction information inspecting unit configured to inspect said inputted second script program and configured to determine whether or not said inputted second script program is executable based upon said restriction information in said first script program,
wherein said execution unit ceases executing said second script program when said restriction information inspecting unit determines that said second script program is not executable.

7. A script processing apparatus comprising:
an analyzing unit configured to analyze a first script program and a second script program, wherein said first script program includes restriction information that defines at least one authorized command in said second script program, and wherein said second script program is inputted by a user;
an execution unit for executing said first script program and said second script program analyzed by said analyzing unit; and
a restriction information inspecting unit for inspecting said inputted second script program and configured to determine whether or not said inputted second script program is executable based upon said restriction information in said first script program,
wherein said execution unit ceases executing said second script program when said restriction information inspecting unit determines that said second script program is not executable.

8. An interpreter for use by a computer apparatus comprising:
analyzing program code configured to analyze a first script program and a second script program, wherein said first script program includes restriction information that defines at least one authorized command in said second script program, and wherein said second script program is inputted by a user;
execution program code for executing said first script program and said second script program analyzed by said analyzing program code;
restriction information copying program code configured to copy said restriction information in said first script program; and
restriction information inspecting program code configured to inspect said inputted second script program and configured to determine whether or not said inputted second script program is executable according to said restriction information copied by said restriction copying program code,
wherein said execution program code ceases executing said second script program when said restriction information inspecting program code determines that said second script program is not executable.

9. A computer apparatus comprising:
a processor;
an interpreter executed by said processor, wherein said interpreter includes analyzing program code configured to analyze a first script program and a second script program, wherein said first script program includes restriction information that defines at least one authorized command in said second script program, and wherein said second script program is inputted by a user;
execution program code configured to execute said first script program and said second script program analyzed by said analyzing program code;
restriction information copying program code configured to copy said restriction information in said first script program; and
restriction information inspecting program code configured to inspect said inputted second script program and configured to determine whether or not said inputted second script program is executable based upon said restriction information copied by said restriction copying program code,
wherein said execution program code ceases executing said second script program when said restriction information inspecting program code determines that said second script program is not executable.

10. A script processing method for executing a first script program, said first script program including restriction information that defines at least one authorized command in a second script program, comprising:
copying the restriction information from said first script program;
inputting said second script program while executing said first script program;
inspecting said inputted second script program and determining whether or not said inputted second script program is executable in reference to the copied restriction information; and
ceasing execution of said second script program if a determination of said determining is not executable.

11. A script processing method comprising:
executing a first script program;
prompting an input of a second script program while said first script program is executing;
receiving said second script program;
determining whether or not said received second script program is executable based upon restriction information contained in said first script program;
executing said second script program when said determining determines said second script program is executable; and
ceasing execution of said second script program if said determining determines said second script program is not executable.

12. A script processing method comprising:
executing a first script program;
copying restriction information in said first scripting program;
prompting an input of a second script program while said first script program executes;
receiving said second script program; and
determining whether or not said received second script program is executable with reference to said copied restriction information executing said second script program when a determination of said determining step is executable; and
ceasing execution of said second script program if said determining determines said second script program is not executable.

13. A script processing program product for executing a script program on a computer, comprising:
first program code executing a first script program and a second script program;
second program code accepting an input of said second script program while said first script program executes; and
third program code determining whether or not said accepted second script program is executable based upon restriction information contained in said first script program,
wherein if the determination of said third program code is that said second script program not executable, said third program code ceases execution of the first program code.

14. A script processing program product for executing a script program on a computer, comprising:
first program code executing a first script program and a second script program;
second program code copying restriction information contained in said first script program;
third program code accepting an input of said second script program while said first script program executes; and
fourth program code determining whether or not said accepted third script program is executable with reference to copied restriction information by said second program code,
wherein if the determination of said fourth program code is that said second script program is not executable, said fourth program code ceases execution of the first program code.

15. A script program product executed by a computer, comprising:
first program code for prompting an input of an input script program;
restriction information for restricting a command useable by the input script program inputted by said prompt function; and
second program code configured to inspect whether or not said input script program inputted by said first program code is executable based upon said restriction information, and configured to cease execution of said input script program when an inspection result indicates that said input script program is not executable.
